(19) United States
(12) Patent Application Publication
(10) Pub. No.: US 2026/0211380 A1
(43) Pub. Date: Jul. 23, 2026

(54) Measurement Methods and Systems for a Motion Control System

(71) Applicant: Siemens Aktiengesellschaft, München (DE)

(72) Inventors: Bing Han Hong, Nanjing (CN); Sheng Zhi Xing, Nan Jing (CN); Shu Ning Liu, Nanjing (CN)

(73) Assignee: Siemens Aktiengesellschaft, München (DE)

(21) Appl. No.: 19/139,336

(22) PCT Filed: Dec. 14, 2022
(86) PCT No.: PCT/CN2022/139059

§ 371 Date: Jun. 14, 2025

(51) Int. Cl. G05B 13/02

(52) U.S. Cl. CPC G05B 13/024

(57) ABSTRACT

Various embodiments include a measurement method for a motion control system. An example includes: wirelessly connecting to a web server of a driver in the motion control system and initiating an auto-optimization function in an application scenario; collecting data of a running state of the motion control system in the application scenario; analyzing the data of the running state of the motion control system collected under the application scenario and the auto-optimization option in the application scenario, and obtaining a measurement result optimization parameter of the running state; and providing the measurement result optimization parameter of the running state to the driver through the wireless connection to enable the driver to optimize parameters according to the measurement result optimization parameter of the running state.

### CROSS-REFERENCE TO RELATED APPLICATIONS

This application is a U.S. National Stage Application of International Application No. PCT/CN2022/139059 filed Dec. 14, 2022, the contents of which are hereby incorporated by reference in their entirety.

### TECHNICAL FIELD

The present disclosure relates motion control systems. Various embodiments of the teachings herein include measurement methods and measurement systems for enhancing the perception capability of the motion control system.

### BACKGROUND

In configuring motion control systems, it is necessary to measure operating conditions of relevant machinery and equipment in the motion control system, such as vibration, acceleration, angle, noise, etc. to obtain the optimized performance of the machine. In the prior art, due to a limited perception capability and computational analysis capability of a driver and motor system in the motion control system, professional measurement and analysis equipment is required.

In actual operation, these professional measurement and analysis devices need to apply their proprietary analysis software to analyze and obtain measurement result optimization parameter. These measurement results cannot be directly read by the configuration tools of the driver but have to be manually inputted into the driver. Then complete the parameter setting of the driver to optimize the operating performance of the equipment. Additionally, in actual field operations, the measurement sensors in these professional measurement and analysis equipment require cables or other connecting devices to connect to the relevant machinery and equipment. The cables or other connecting devices will not only affect the payload of the motion control system, but also limit the movement of the machine. The cost of these professional measurement and analysis equipment is expensive, and the procurement cycle is long. The professional measurement and analysis equipment cannot be easily and quickly obtained, which in turn affects the configuration cycle of the motion control system and ultimately affects the measurement efficiency. Furthermore, these professional measurement and analysis equipment require professionals to collect data on site, and use professional analysis tools for analysis and commissioning, which makes the configuration process more complicated. Generally, applying these professional measurement and analysis equipment for motion control system measurement not only has high measurement cost, complex measurement process, but also low measurement efficiency.

Currently, with an increased computing power of drivers and an enhancement of edge computing devices, more and more on-site data collection and analysis can be performed without installing measuring instruments. Specifically, the edge computing device is connected to a local sensor, and high-speed data collection is performed through the local sensor to obtain operation information of the relevant machinery and equipment. The response parameters of the motion control system can then be obtained to optimize the performance of the related machinery and equipment in the motion control system. Although this solution can optimize the parameters of the motion control system remotely, that is, in the cloud, the local sensors, such as wireless vibration sensors, are relatively expensive. In actual operation, special instruments are required to complete the collection of the operating data, so it is not widely used in practical applications.

### SUMMARY

Teachings of the present disclosure include measurement methods, measurement apparatus, measurement systems, and electronic devices for enhancing the perception capability of a motion control system. These embodiments may simplify the configuration and optimization process of the motion control system and improves the effectiveness of the configuration and optimization of the motion control system.

As an example, some embodiments include a measurement method comprising: wirelessly connecting to a web server of a driver in the motion control system and initiates an auto-optimization function in an application scenario; collecting data of the running state of the motion control system in the application scenario; analyzing the data of the running state of the motion control system collected under the auto-optimization option in the application scenario, and obtaining the measurement result optimization parameter of the running state; and inputting the measurement result optimization parameter of the running state into the driver through the wireless connection, to enable the driver to optimize parameters according to the optimized parameters of the running state.

As another example, some embodiments include a measurement apparatus comprising: a communication unit, configured to wirelessly connect to a web server of a driver in the motion control system; a sensor, configured to collect data of the running state of the motion control system in an application scenario; and a processor, configured to analyze the data of the running state of the motion control system collected under the auto-optimization option in application scenario, and obtain the measurement result optimization parameter of the running state; the communication unit further configured to input the measurement result optimization parameter of the running state into the driver through the wireless connection, to enable the driver to optimize parameters according to the measurement result optimization parameter of the running state.

As another example, some embodiments include a measurement system comprising: a mobile terminal, configure to connect a web server of a driver in the motion control system wirelessly, and start an auto-optimization function; to collect data of the running state of the motion control system in an application scenario; to analyze the data of the running state collected under the auto-optimization option in the application scenarion and obtain a measurement result optimization parameter of the operation state; and a driver, configured to receive the measurement result optimization parameter of the operation state and optimize parameters according to the measurement result optimization parameter of the operation state.

Some embodiments of the present disclosure combine control system measurement, measurement result analysis, auto-optimization algorithm and driver configuration with the mobile terminal. The series of operations of collecting of the running state data from the motion control system, data analysis, parameter calculation, wireless communication with the driver, and the configuration of the parameters of the driver can be completed at one time. The provided solutions can also enable the drive and the payload of the motion control system to have full closed-loop perception and parameter adjustment capabilities. Therefore, the solutions not only simplify the configuration and optimization process of the motion control system, but also improve the effectiveness of the configuration and optimization of the motion control system.

### BRIEF DESCRIPTION OF THE DRAWINGS

The above-mentioned characteristics, technical features, and advantages are further described below in a clear and easy-to-understand manner through the description of the example embodiments in conjunction with the accompanying drawings, wherein:

FIG. 1 is a schematic diagram of an example application scenario of one embodiment of the present disclosure in which the various methods described herein may be implemented;

FIG. 2 is a flowchart of an example measurement method incorporating teachings of the present disclosure;

FIG. 3 is a block diagram of an example measurement apparatus incorporating teachings of the present disclosure;

FIG. 4 is a flowchart of another example measurement method incorporating teachings of the present disclosure;

FIG. 5 is a flowchart of an example measurement method incorporating teachings of the present disclosure;

FIG. 6 is a block diagram of another example measurement apparatus incorporating teachings of the present disclosure;

FIG. 7 is a flowchart of an example measurement method incorporating teachings of the present disclosure; and

FIG. 8 is a block diagram of an example electronic device that can be used to implement teachings of the present disclosure.

Reference Numbers:

| | | |
|---|---|---|
| 110: fixed base | 120: drive chain | 130: moving part |
| 140: driver | 141: Wi-Fi adapter | 150: motor |
| 151: encoder | 160: mobile terminal | 170: wireless connection |
| 30: mobile terminal | 31: driver | 301: sensor |
| 302: browser | 303 and 312: processor | 304 and 311: communication unit |
| 60: type of collected data | 601: DeviceMotionEvent | 602: DeviceAcceleration |
| 603: DeviceRotationRate | 60: DeviceOrientationEvent | 605: MediaAudio |
| 606: MediaVideo | 800: electronic device | 801: calculation unit |
| 802: ROM | 803: RAM | 804: bus |
| 805: I/O interface | 806: input unit | 807: output unit |
| 808: storage unit | 809: communication unit | |

S201: wirelessly connecting to a web server of a driver in the motion control system and
initiating an auto-optimization function in an application scenario
S202: collecting data of a running state of the motion control system in the application scenario
S203: analyzing the data of the running state of the motion control system collected under the
application scenario and the auto-optimization option in the application scenario, and
obtaining a measurement result optimization parameter of the running state
S204: inputting the measurement result optimization parameter of the running state into the
driver through the wireless connection, to enable the driver to optimize parameters according
to the measurement result optimization parameter of the running state
S401: initiating the measurement system of the motion control system. This is also the
preparation stage of the measurement system
S402: establishing communication of the measurement system
S403: initiating the auto-optimization function of the mobile terminal 160 which binds with
payload of the motion control system
S404: initiating the auto-optimization function of the driver 140
S405: continuously recording the operation data of the motion control system according
to the payload
S406: analyzing the payload data and obtaining the analysis result through calculation
S501: authorizing an access to the mobile terminal sensor 301 according to different
browsers 302
S502: initiating the operation signal and starting to collect data
S503: triggering the collection event recording function
S504: recording the event data and adding time stamp to the data after the relevant
event is triggered
S505: pausing or terminating the collection of the operation data of the motion
control system
S701: classifying the continuously collected data according to the application scenario
to different data type
S702: performing data analysis according to the data type
S703: analyzing the relationship between the collected data and the operating parameters
S704: recording the data analysis results and inputting the measurement result optimization
parameter of the running state into the drive 31 through the wireless connection

### DETAILED DESCRIPTION

In order to make the purpose, technical solutions, and advantages of the teachings of the present disclosure clearer, example embodiments are further described in detail. Embodiments of the present disclosure are described in more detail below with reference to the accompanying drawings. While certain embodiments are shown in the drawings, the present disclosure may be embodied in various forms and should not be construed as limited to the embodiments set forth herein, but rather are provided for the purpose of a more thorough and complete understanding of the present disclosure. The drawings and example embodiments of the present disclosure are only for exemplary purposes, and are not intended to limit the protection scope of the present disclosure.

As used herein, the term “including” and variations thereof are open-ended inclusions, i.e., “including but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions of other terms will be given in the description below. It should be noted that the concepts such as “first” and “second” mentioned in the present disclosure are only used to distinguish different devices, modules or units, and are not used to limit the order of functions performed by these devices, modules or units or interdependence.

It should be noted that the modifications of “a” and “a plurality” mentioned in the present disclosure are illustrative rather than restrictive, and those skilled in the art should understand that unless the context clearly indicates otherwise, they should be understood as “one or a plurality of”. multiple”. The names of messages or information exchanged between multiple devices in the embodiments of the present disclosure are only used for illustrative purposes and are not used to limit the scope of these messages or information.

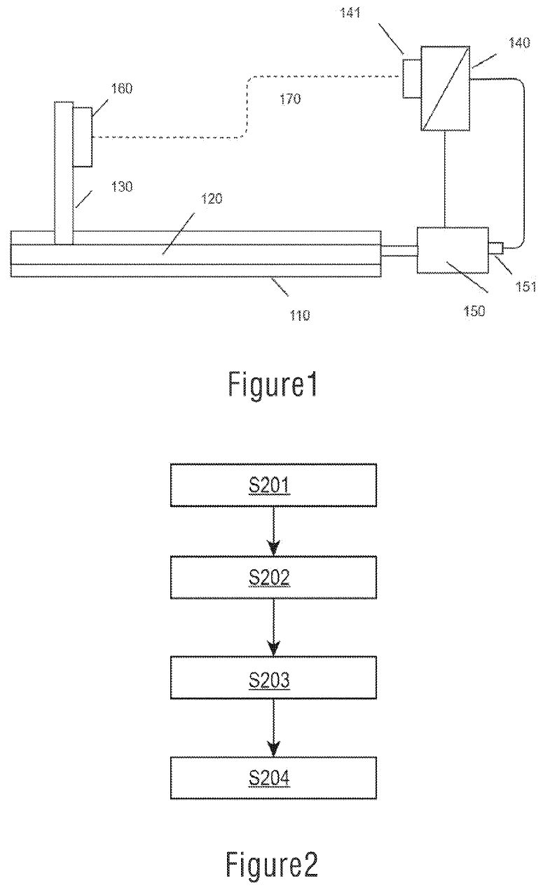

FIG. 1 shows a schematic diagram of an example application scenario in which various methods described herein can be implemented incorporating teachings of the present disclosure. Specifically, FIG. 1 shows a structure of an example motion control system incorporating teachings of the present disclosure. The motion control system includes a driver 140, a motor 150, and a mobile terminal 160. The payload of the motion control system includes a fixed base 110, a drive chain 120, and a moving part 130. As shown in FIG. 1, the mobile terminal 160 is bound with the moving part 130, the moving part 130 is carried on the drive chain 120, and the moving part 130 and the mobile terminal 160 move with the operation of the drive chain 120.

In some embodiments, the motor 150 may include a motor encoder 151, and the motor encoder 151 is connected to the driver 140. When the motor 150 is working, the motor encoder 151 can provide the driver 140 with an accurate motor rotor position information and speed information, thereby improving the accuracy of data collection.

The driver 140 includes an adapter, such as a wireless adapter 141, which can communicate with other electronic devices through its wireless commissioning interface. For example, the driver 140 can run the web server function by cooperating with the wireless commissioning interface, and the mobile terminal 160 can be accessed through the wireless connection 170.

The mobile terminal 160 may be a general mobile device, such as a smart phone, a tablet computer, a notebook computer, a desktop computer, a smart watch, and such. The mobile terminal 160 integrates a micro-electromechanical system (MEMS), supports browsers HTML5 and above, and can connect to a web server through Wi-Fi.

The mobile terminal 160 integrates the relevant functions of the micro-electromechanical system, such as the integration of professional measuring instruments to measure vibration, noise, acceleration and other functions. The mobile terminal 160 carries out continuous data collection of the running state, analyzes the collected running state data to obtain the running state measurement result, then calculates the parameters of the running state measurement result according to the automatic optimization algorithm, obtains the measurement result optimization parameter, and accesses the web page of the driver 140 through the wireless connection. The server inputs the obtained measurement result optimization parameter into the driver 140, and finally the driver 140 performs parameter optimization operations according to the inputted measurement result optimization parameter. The mobile terminal 160 activates the corresponding test auto-optimization options for different application scenarios, obtains the measurement result optimization parameter, and completes the drive parameter optimization operation according to the automatic optimization algorithm, thereby realizing the optimization and commissioning of the motion control system and troubleshooting. Further, the driver 140 is connected with the mobile terminal 160 through wireless communication to obtain optimized parameters for commissioning a series of parameter operations of the driver 140, so that the driver 140 and the payload conditions of the motion control system have full closed-loop perception and parameter adjustment capabilities.

FIG. 2 is a flowchart of an example measurement method incorporating teachings of the present disclosure. With reference to FIG. 1, the working process specifically includes:
S201: wirelessly connecting to a web server of a driver in the motion control system and initiating an auto-optimization function in an application scenario. Herein, the driver 140 operates the web server function by cooperating with the wireless commissioning interface, and is connected to the wireless commissioning adapter 141. The mobile terminal 160 is connected to the web server of the driver 140 through the wireless connection 170, and the load of the mobile terminal 160 and the motion control system is fixed.

As shown in FIG. 1, the mobile terminal 160 and the mobile device 130 are reliably fixed, and for different applications The scene initiates the corresponding automated optimization options. Wherein, the automatic optimization option, may be a third-party application or a built-in application of the mobile terminal 160. Further, the automatic optimization option can be manually selected by the user or automatically generated according to the application scenario.
S202: collecting data of a running state of the motion control system in the application scenario. Specifically, the mobile terminal 160 opens the corresponding web page of the web server of the driver 140, while reliably binds with the payload of the motion control system. After binding, the mobile terminal 160 will follow the synchronous movement of the payload, and then collect the relevant parameters of the payload movement, such as velocity, acceleration, rotational rate, sound frequency, etc. The mobile terminal 160 activates corresponding auto-optimization options for different application scenarios. In some embodiments, the auto-optimization option, may be a third-party application or a built-in application of the mobile terminal 160. Furthermore, the auto-optimization option can be manually selected by the user or automatically generated according to the application scenario.

In some embodiments, the data to be collected in different application scenarios includes at least one of the followings: DeviceMotionEvent, DeviceAcceleration, DeviceRotationRate, DeviceOrientationEvent, MediaAudio, Media Video, etc. Furthermore, according to different browsers, the mobile terminal 160 authorizes the browser to access the sensor of the mobile terminal, then records the collected data of the sensor, and stamps a timestamp in the collected data.
S203: analyzing the data of the running state of the motion control system collected under the application scenario and the auto-optimization option in the application scenario, and obtaining a measurement result optimization parameter of the running state. Specifically, the mobile terminal 160 classifies the collected data according to the application scenario to obtain the data type. In some embodiments, the obtained data type may be noise data, acceleration data, or rotation data, or the like. Then, the mobile terminal 160 analyzes the data according to the obtained data type, wherein the analysis method may be time series analysis, frequency domain analysis, or attribution analysis. The mobile terminal 160 associates the analysis results with the operating parameters of the motion control system, records the analysis results, and obtains measurement result optimization parameter.
S204: inputting the measurement result optimization parameter of the running state into the driver through the wireless connection, to enable the driver to optimize parameters according to the measurement result optimization parameter of the running state. Specifically, if the mobile terminal 160 does not obtain the optimized parameters, the mobile terminal 160 associates the cause of the problem with the parameters of the driver 140 and inputs the obtained measurement result optimization parameter into the driver 140 through the web server of the driver 140. Optionally, the driver 140 can record the inputted parameters, which can be used to conquer the similar problems that occur during the next optimization cycle; or if the mobile terminal 160 obtains the optimized parameter, the mobile terminal 160 inputs the optimized parameter into the driver 140 through the web server, wherein the optimized parameter is used to indicate the termination of the measurement.

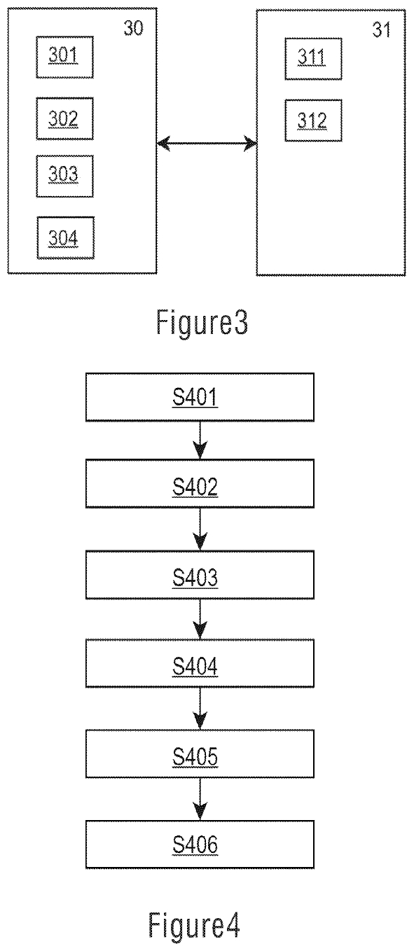

FIG. 3 is a block diagram for configuring measurement result optimization parameter between a mobile terminal and a driver incorporating teachings of the present disclosure. Among them, the mobile terminal 30 integrates a micro-electromechanical system MEMS, supports HTML5 and browsers above HTML5, and can connect to a web server through Wi-Fi.

The mobile terminal 30 specifically includes: the sensor 301, which integrates the related functions of the micro-electromechanical system, contains extremely sensitive digital measurement means, and can record information such as acceleration, angle, magnetic field, and such. Modern smartphones also feature audio and video capture as standard. The mobile terminal 30 collects running state data along with the movement of the moving part. The collection of operating data is continuously performed during the operation of the mobile terminal 30. According to the application scenario and analysis requirements, the sensor 301 collects at least one of the followings: DeviceMotionEvent; DeviceAcceleration; DeviceRotationRate; DeviceOrientationEvent; MediaAudio; or MediaVideo.

In some embodiments, the browser 302, which supports HTML5 and the text above HTML5, uses the latest version of the browser. All the browsers of the above-mentioned versions all support JavaScript. The JavaScript in the browser 302 can record the data collected by the sensor 301 in the memory of the browser 302 and stamp the time stamp according to the clock of the mobile terminal 30.

The mobile terminal 30 allows the browser 302 to access the built-in web server of the driver 31 through Wi-Fi, so that the mobile terminal 30 can obtain all functions after opening the web page without installing any program.

The processor 303 is configured to analyze the collected running state data to obtain the running state measurement result and then perform parameter calculation on the running state measurement result according to the automatic optimization algorithm to obtain the measurement result optimization parameter.

Among them, the processor 303 has a strong computing capability, samples, analyzes and calculates the obtained operating data of the mechanical equipment, and stores the analysis results in the memory of the mobile terminal 30.

The communication unit 304 is configured to send the obtained measurement result optimization parameter to the driver 31 through a wireless such as Wi-Fi, to perform parameter optimization operations.

The driver 31 is connected with the motor to control the movement of the motor, wherein the driver 31 mainly includes a communication module 311, such as a wireless commissioning adapter, for communicating with terminal 30 the mobile through Wi-Fi. Specifically, the mobile terminal 30 is connected to the wireless commissioning adapter of the driver 31 through Wi-Fi, and the wireless commissioning adapter cooperates with the wireless commissioning interface to access the web server function of the operating driver 31.

The driver 31 further includes a processor 312 for performing optimization processing on the received measurement result optimization parameter, wherein the driver 31 uses the auto-optimization function of the measurement result optimization parameter inputted from the mobile terminal 30 to complete the parameter optimization operation, thereby realizing configuration optimization process of the motion control system and the troubleshooting function.

Optically, if the driver 31 is connected to the motor encoder, as shown in FIG. 1, the driver 31 can read accurate rotor position information and speed information of the motor at the same time, thereby improving the accuracy of data collection.

FIG. 4 is a flowchart of an example measurement method applied to the measurement of a motion control system incorporating teachings of the present disclosure. With reference to FIG. 1, it specifically includes:
S401: initiating the measurement system of the motion control system. This is also the preparation stage of the measurement system. Specifically, the motion control system is assembled and connected to each mechanical equipment of the payload. After the check of the safe operation of each equipment is fulfilled, the driver 140 starts to run, that is, the completion of the preliminary commissioning of the equipment and the system. In such, the normal operation of the basic functions is ensured. And the preparation stage of the measurement system is completed.
S402: establishing communication of the measurement system. Specifically, the driver 140 activates the web server function and connects the wireless commissioning adapter 141. The mobile terminal 160 is connected to the web server and opens the corresponding web page.
S403: initiating the auto-optimization function of the mobile terminal 160 which binds with payload of the motion control system.
S404: initiating the auto-optimization function of the driver 140;

Wherein the above-mentioned S402, S403, and S404, the sequence between the steps can be flexibly adjusted, that is, the sequence between the steps S402, S403, and S404, can be adjusted and configured flexibly according to the needs of the actual operation.
S405: continuously recording the operation data of the motion control system according to the payload. Specifically, the motor 150 starts to run, the drive chain 120 starts to operate according to the set control logic, and the mobile terminal 160 continuously records the running payload data with the movement of the moving part 130 until sufficient data for testing is obtained and then sends a message to instruct the driver 140 to pause.
S406: analyzing the payload data and obtaining the analysis result through calculation. Specifically, if the result analyzed by the mobile terminal 160 obtains the purpose of optimization, a message is sent to instruct the driver 140 to terminate the operation; if the result analyzed by the mobile terminal 160 does not obtain the purpose of optimization, a message is sent to instruct the driver 140 to restart the operation. If the number of times does not exceed the limit, repeat S404. Furthermore, if it is necessary to adjust the machinery for optimization, the operation of the driver 140 is temporarily paused, and the mechanical equipment is adjusted. As shown in FIG. 1 and FIG. 4, the example embodiments combine the control system measurement, measurement result analysis, auto-optimization algorithm and the driver configuration with the mobile terminal. The series of operations of collecting of the running state data from the motion control system, data analysis, parameter calculation, wireless communication with the driver, and the configuration of the parameters of the driver can be completed at one time. The provided solutions can also enable the drive and the payload of the motion control system to have full closed-loop perception and parameter adjustment capabilities.

FIG. 5 is a flowchart of an example measurement method for collecting data from a motion control system incorporating teachings of the present disclosure. Combined with FIG. 3 and FIG. 4, the measurement method specifically includes:
S501: authorizing an access to the mobile terminal sensor 301 according to different browsers 302. Specifically, in the procedure of the mobile terminal 30 recording and controlling the operation data of the motion system, according to different application scenarios, the data types to be measured are different; therefore, the sensors 301 of the mobile terminal 30 that need to be activated are different. Furthermore, since the browsers 302 used by the mobile terminal 30 are different, the mobile terminal 30 needs to authorize the access to the mobile terminal sensor 301 to the different browsers 302.
S502: initiating the operation signal and starting to collect data. Specifically, according to the application scenario and analysis requirements, the sensor 301 collects at least one of the following data: DeviceMotionEvent; DeviceAcceleration; DeviceRotationRate; DeviceOrientationEvent; MediaAudio; or MediaVideo.
S503: triggering the collection event recording function. Specifically, the mobile terminal 30 detects and receives a signal that the motion control system starting to operate according to the control logic. The mobile terminal 30 triggers a recording function of the collection event.
S504: recording the event data and adding time stamp to the data after the relevant event is triggered. The latest version of the browser 302, which supports the hypertext markup language HTML5 and above is preferred. The browsers of the above-mentioned versions all support JavaScript. Specifically, the JavaScript in the browser 302 records the data collected by the sensor 301 in the memory of the browser 302, and adds time stamp to the data according to the clock of the mobile terminal 30.
S505: pausing or terminating the collection of the operation data of the motion control system. Specifically, if the mobile terminal 30 obtains enough data in the continuous data collection, as described in step S405, the mobile terminal 30 sends information of pausing the operation of the driver 31; or If the mobile terminal 30 does not obtain enough data in the continuous data collection, and the driver 31 does not receive a tentatively running command, the collected data can be temporarily stored in the memory of the browser 302 to assist the next step of the data analysis.

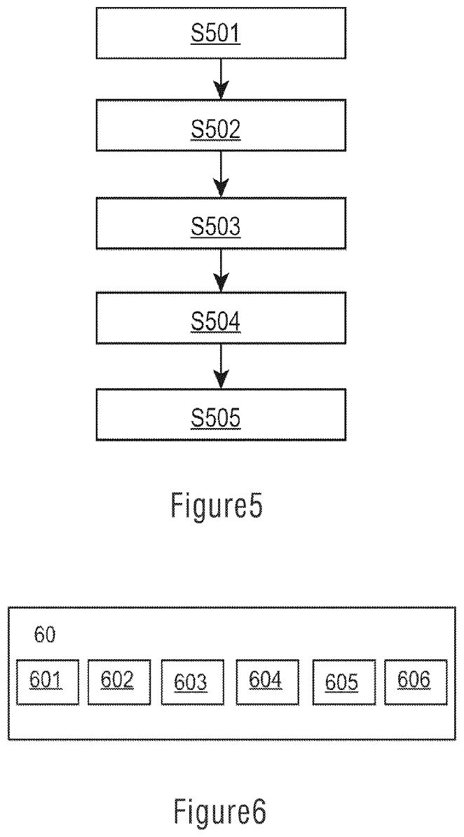

FIG. 6 shows a schematic diagram of the data to be collected by the mobile terminal sensor 301 incorporating teachings of the present disclosure, which is described with FIG. 3 and FIG. 5, wherein the data 60 to be collected by the sensor 301 includes at least one of the followings: DeviceMotionEvent 601, DeviceAcceleration 602, DeviceRotationRate 603, DeviceOrientationEvent 604, MediaAudio 605, MediaVideo 606, etc. The type of data collected by the sensor 301 needs to be determined according to different application scenarios and the analysis requirements.

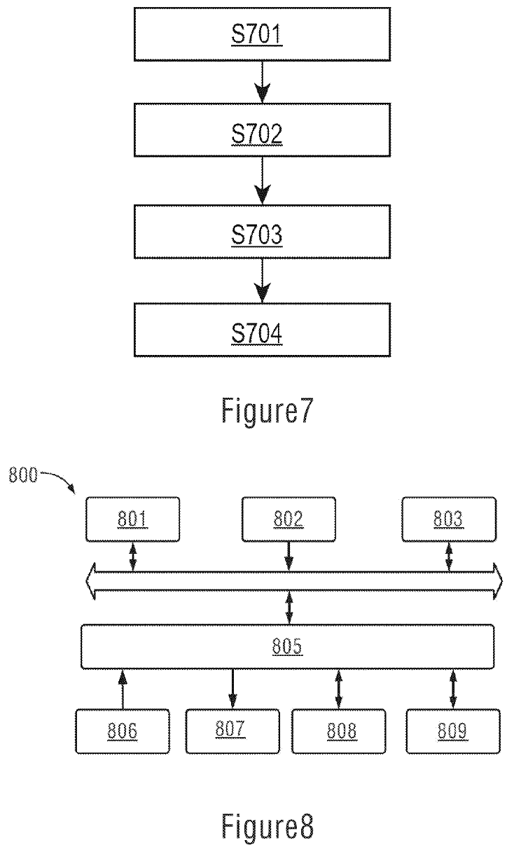

FIG. 7 is a flowchart of an example measurement method for analyzing data of a motion control system incorporating teachings of the present disclosure, which is described with FIG. 3 and FIG. 4. The flowchart of the measurement method includes:
S701: classifying the continuously collected data according to the application scenario to different data type. Specifically, the obtained data types include at least one of the followings: noise data; acceleration data; or rotate data.
S702: performing data analysis according to the data type. Specifically, the method for data analysis further includes: the mobile terminal 30 performs time sequence analysis on the continuously collected data of the running state according to the data type; the mobile terminal 30 performs frequency domain analysis on the continuously collected data of the running state according to the data type; or the mobile terminal 30 performs attribution analysis on the continuously collected data of the running state according to the data type.
S703: analyzing the relationship between the collected data and the operating parameters. Specifically, after analyzing the collected data, if the mobile terminal 30 obtains the optimization purpose according to the continuously collected data, the mobile terminal 30 sends the information of terminating the operation of the driver 31; or If the mobile terminal 30 does not obtain the purpose of optimization according to the continuously collected data, the mobile terminal 30 sends information to restart the operation of the driver 31.
S704: recording the data analysis results and inputting the measurement result optimization parameter of the running state into the drive 31 through the wireless connection. Specifically, if the mobile terminal 30 does not obtain the measurement result optimization parameter of the running state, the mobile terminal 30 associates the cause of the problem with the parameters of the driver 31, and inputs the parameters into the driver 31 through the web server of the driver 31, so as to facilitate the next optimization cycle to conquer these issues in the process; or

If the mobile terminal 30 obtains the measurement result optimization parameter of the running state, the mobile terminal 30 inputs the measurement result optimization parameter into the driver 31 through the web server of the driver 31, wherein the optimized parameters are used to instruct the termination of the measurement.

Through the above-mentioned operation cycle of startup, collection, analysis, and optimization, the driver and the payload of the motion control system can form a close-loop, which can continuously optimize the performance of the entire motion control system under the operation of a very small number of personnel. Since the communication is wireless, it does not interfere with the movement of the moving parts.

As another example, some embodiments include an electronic device including: at least one processor; and a memory communicatively connected to the at least one processor. The memory stores a computer program executable by the at least one processor for causing the electronic device to perform one or more of the methods as described herein when executed by the at least one processor.

As another example, some embodiments include a non-transitory computer-readable storage medium storing a computer program, wherein the computer program, when executed by a processor of a computer, is used to enable the computer to execute one or more of the computer programs as described herein.

As another example, some embodiments include a computer program product, comprising a computer program, wherein the computer program, when executed by a processor of a computer, is used to enable the computer to perform one or more of the methods described herein.

Referring to FIG. 8, a block diagram of an electronic device 800 that can serve as a server or a client of the present disclosure will now be described, which is an example of a hardware device that can be applied to various aspects of the present disclosure. Electronic devices are intended to represent various forms of digital electronic computer devices, such as laptop computers, desktop computers, workstations, personal digital assistants, servers, blade servers, mainframe computers, and other suitable computers. Electronic devices may also represent various forms of mobile devices, such as personal digital processors, cellular phones, smart phones, wearable devices, and other similar computing devices. The components shown herein, their connections and relationships, and their functions are by way of example only, and are not intended to limit implementations of the disclosure described and/or claimed herein.

As shown in FIG. 8, the electronic device 800 includes a computing unit 801, which can be programmed according to a computer program stored in a read only memory (ROM) 802 or loaded into a random-access memory (RAM) 803 from a storage unit 808. Various appropriate actions and processes are performed. In the RAM 803, various programs and data necessary for the operation of the device 800 can also be stored. The computing unit 801, the ROM 802, and the RAM 803 are connected to each other through a bus 804. An input/output (I/O) interface 805 is also connected to bus 804.

Various components in the electronic device 800 are connected to the I/O interface 805, including: an input unit 806, an output unit 807, a storage unit 808, and a communication unit 809. The input unit 806 may be any type of device capable of inputting information to the electronic device 800, and the input unit 806 may receive input numerical or character information and generate key signal input related to user settings and/or function control of the electronic device. The output unit 807 may be any type of device capable of presenting information, and may include, but is not limited to, a display, speakers, video/audio output terminals, vibrators, and/or printers. The storage unit 804 may include, but is not limited to, magnetic disks and optical disks. Communication unit 809 allows electronic device 800 to exchange information/data with other devices through computer networks such as the Internet and/or various telecommunication networks, and may include, but is not limited to, modems, network cards, infrared communication devices, wireless communication transceivers, and/or chips Groups such as Bluetooth™ devices, Wi-Fi devices, WiMax devices, cellular communication devices and/or the like.

Computing unit 801 may be various general-purpose and/or special-purpose processing components with processing and computing capabilities. Some examples of computing units 801 include, but are not limited to, central processing units (CPUs), graphics processing units (GPUS), various specialized artificial intelligence (AI) computing chips, various computing units that run machine learning model algorithms, digital signal processing processor (DSP), and any suitable processor, controller, microcontroller, etc. The computing unit 801 performs the various methods and processes described above. For example, in some embodiments, the steps of the measurement methods S201-S204, S401-S406, S501-S505, and S701-S704 may be implemented as a computer software program tangibly embodied on a machine-readable medium, such as storage unit 808. In some embodiments, part or all of the computer program may be loaded and/or installed on the electronic device 800 via the ROM 802 and/or the communication unit 809. In some embodiments, the computing unit 801 may be configured to perform the steps of the measurement methods S201-S204, S401-S406, S501-S505, and S701-S704 by any other suitable means (e.g., by means of firmware).

Program code for implementing the methods described herein may be written in any combination of one or more programming languages. These program codes may be provided to a processor or controller of a general-purpose computer, special purpose computer or other programmable data processing apparatus, such that the program code, when executed by the processor or controller, performs the functions/functions specified in the flowcharts and/or block diagrams. Action is implemented. The program code may execute entirely on the machine, partly on the machine, partly on the machine and partly on a remote machine as a stand-alone software package or entirely on the remote machine or server.

In the context of the present disclosure, a machine-readable medium may be a tangible medium that may contain or store a program for use by or in connection with the instruction execution system, apparatus or device. The machine-readable medium can be a machine-readable signal medium or a machine-readable storage medium. Machine-readable media may include, but are not limited to, electronic, magnetic, optical, electromagnetic, infrared, or semiconductor systems, devices, or devices, or any suitable combination of the foregoing. More specific examples of machine-readable storage media would include one or more wire-based electrical connections, portable computer disks, hard disks, random access memory (RAM), read only memory (ROM), erasable programmable read only memory (EPROM or flash memory), fiber optics, compact disk read only memory (CD-ROM), optical storage devices, magnetic storage devices, or any suitable combination of the foregoing.

As used in this disclosure, the terms “machine-readable medium” and “computer-readable medium” refer to any computer program product, apparatus, and/or apparatus for providing machine instructions and/or data to a programmable processor (e.g., magnetic disk, optical disk, memory, programmable logic device (PLD)), including a machine-readable medium that receives machine instructions as machine-readable signals. The term “machine-readable signal” refers to any signal used to provide machine instructions and/or data to a programmable processor.

The systems and techniques described herein can be implemented on a computing system that includes back-end components (e.g., as a data server), or a computing system that includes middleware components (e.g., an application server), or a computing system that includes front-end components (e.g., a user's computer having a graphical user interface or web browser through which a user may interact with implementations of the systems and techniques described herein), or including such back-end components, middleware components, Or any combination of front-end components in a computing system. The components of the system may be interconnected by any form or medium of digital data communication (e.g., a communication network). Examples of communication networks include: Local Area Networks (LANs), Wide Area Networks (WANs), and the Internet.

The teachings of the present disclosure have been shown and described in detail above through the accompanying drawings and example embodiments, however, the scope of the present disclosure is not limited to these disclosed embodiments. Other solutions derived therefrom by those skilled in the art also fall within the protection scope of the present disclosure.

What is claimed is:

1. A measurement method for a motion control system, the method comprising:
wirelessly connecting to a web server of a driver in the motion control system and initiating an auto-optimization function in an application scenario;
collecting data of a running state of the motion control system in the application scenario;
analyzing the data of the running state of the motion control system collected under the application scenario and the auto-optimization option in the application scenario, and obtaining a measurement result optimization parameter of the running state; and
providing the measurement result optimization parameter of the running state to the driver through the wireless connection, to enable the driver to optimize parameters according to the measurement result optimization parameter of the running state.

2. The method of claim 1, wherein collecting data of the running state of the motion control system in the application scenario comprises:
opening a corresponding web page of the web server of the driver;
initiating the auto-optimization function while binding with payload of the motion control system;
continuously recording the operation data of the motion control system according to the payload; and
pausing or terminating the collection of the operation data of the motion control system, according to a collection amount of the operation data and a preset maximum optimization limitation.

3. The method of claim 2, wherein the data to be collected in the application scenario comprises at least one of the following:
DeviceMotionEvent,
DeviceAcceleration,
DeviceRotationRate,
DeviceOrientationEvent,
MediaAudio, or
MediaVideo.

4. The method of claim 2, wherein continuously recording the operation data of the motion control system according to the payload comprises;
authorizing an access to a sensor to at least one of different browsers; and
recording the data from the sensor and adding time stamps on the data.

5. The method of claim 1, wherein analyzing the data of the running state of the motion control system collected under the application scenario and the auto-optimization option in the application scenario, and obtaining a measurement result optimization parameter of the running state comprises:
classifying the collected data according to the application scenario to obtain a data type;
performing data analysis according to the data type to obtain an analysis result; and
associating the analysis results with operating parameters of the motion control system, recording the analysis results, and obtaining the measurement result optimization parameter.

6. The method of claim 5, wherein the obtained data types comprise at least one of the following:
noise data,
acceleration data, or
rotate data.

7. The method of claim 5, wherein the data analysis further comprises:
performing time sequence analysis on the continuously collected data of the running state according to the data type;
performing frequency domain analysis on the continuously collected data of the running state according to the data type; or
performing attribution analysis on the continuously collected data of the running state according to the data type.

8. The method of claim 1, further comprising:
detecting and receiving a signal that the motion control system starting to operate according to a control logic;
triggering a recording function of a collection event; and
performing data collection according to the collection event.

9. The method of claim 1, wherein pausing or terminating the collection of operation data of the motion control system comprises:
sending information to pause an operation of the driver after obtaining sufficient data in continuous data collection; or
sending information to terminate the operation of the driver after obtaining a purpose of optimization according to continuously collected data; or
sending information to restart the operation of the driver if does not obtain a purpose of optimization according to the continuously collected data.

10. The method of claim 1, wherein inputting the measurement result optimization parameter of the running state into the driver through the wireless connection comprises:
associating a cause of the problem with the parameters of the driver, and inputting the parameters into the driver through the web server if does not obtain satisfactory measurement result optimization parameter of the running state; or
inputting the optimized parameters into the driver through the web server if obtains satisfactory measurement result optimization parameter of the running state, wherein the optimized parameters are used to indicate termination of the measurement.

11. The method of claim 1, wherein the method is executed by a mobile terminal, wherein a micro-electromechanical system (MEMS) integrated in the mobile terminal. The mobile terminal supports browsers HTML5 and above, and the mobile terminal connects to the web server through Wi-Fi.

12. A measurement apparatus for a motion control system, the apparatus comprising:
a communication unit to wirelessly connect to a web server of a driver in the motion control system;
a sensor to collect data of a running state of the motion control system in the application scenario; and
a processor to analyze the data of the running state of the motion control system collected under an auto-optimization option in the application scenario, and obtain a measurement result optimization parameter of the running state;
the communication unit further configured to provide the measurement result optimization parameter of the running state to the driver through the wireless connection, to enable the driver to optimize parameters according to the measurement result optimization parameter of the running state.

13. The measurement apparatus of claim 12, wherein:
the measurement apparatus is further configured to open a corresponding web page of the web server of the driver through the communication unit;
the processor is further configured to initiate the auto-optimization function while the measurement apparatus binds with payload of the motion control system;
the processor is further configured to continuously record the operation data of the motion control system according to the payload; and
the sensor is further configured to pause or terminate a collection of the operation data of the motion control system according to a collection amount of the operation data and a preset maximum optimization limitation.

14. The measurement apparatuses of claim 12, wherein the data to be collected in the application scenario comprises at least one of the following:
DeviceMotionEvent;
DeviceAcceleration,
DeviceRotationRate,
DeviceOrientationEvent,
MediaAudio, or
MediaVideo.

15. The measurement apparatus of claim 12, further comprising: using
a browser to record the data collected by the sensor; and
adding a time stamp on the data.

16. The measurement apparatus of claim 12, wherein the processor is further configured to:
classify the collected data according to the application scenario to obtain a data type;
perform data analysis according to the data type to obtain an analysis result; and
associate the analysis results with operating parameters of the motion control system, record the analysis results, and obtain the measurement result optimization parameter of the running state.

17. The measurement apparatus of claim 12, wherein the obtained data types comprise at least one of the following:
noise data,
acceleration data, or
rotate data.

18. The measurement apparatuses of claim 16, wherein the processor is further configured to:
perform time sequence analysis on the continuously collected data of the running state according to the data type;
perform frequency domain analysis on the continuously collected data of the running state according to the data type; or
perform attribution analysis on the continuously collected data of the running state according to the data type.

19. The measurement apparatuses of claim 12, wherein the sensor is further configured to:
detect and receive a signal that the motion control system starting to operate according to a control logic;
trigger a recording function of a collection event; and
perform data collection according to the collection event.

20. The measurement apparatuses of claim 12, wherein the measurement apparatuses is further configured to:
wirelessly connect the web server of the drive in the motion control system;
send information to pause an operation of the driver after obtaining sufficient data in continuous data collection; or
send information to terminate the operation of the driver after obtaining the purpose of optimization according to the continuously collected data; or
send information to restart the operation of the driver if does not obtain the purpose of optimization according to the continuously collected data.

21. The measurement apparatuses of claim 12, wherein the measurement apparatuses is further configured to:
associate a cause of the problem with the parameters of the driver, and input the parameters into the driver through the web server if does not obtain satisfactory running state measurement result optimization parameter; or
input the optimized parameters into the driver through the web server if obtains satisfactory running state measurement result optimization parameter, wherein the optimized parameters are used to indicate termination of measurement.

22. A measurement system for a motion control system, the measurement system comprising:
a mobile terminal to connect a web server of a driver in the motion control system wirelessly, and initiate an auto-optimization function, to collect data of the running state of the motion control system in the application scenario; to analyze the data of the running state of the motion control system collected under the auto-optimization option in the application scenario and obtain a measurement result optimization parameter of the running state; and
a driver, configured to receive the measurement result optimization parameter of the operation state and optimize parameters according to the measurement result optimization parameter of the running state.

23. The measurement system of claim 22, wherein:
the mobile terminal is further configured to open a corresponding web page of the web server of the driver;
the mobile terminal is further configured to initiate the auto-optimization function while the measurement apparatus binds with payload of the motion control system;
the mobile terminal is further configured to continuously record the operation data of the motion control system according to the payload; and
the mobile terminal is further configured to pause or terminate the collection of the operation data of the motion control system according to a collection amount of the operation data and a preset maximum optimization limitation.

24. The measurement system of claim 22, wherein the data to be collected in the application scenario comprises at least one of the following:
DeviceMotionEvent,
DeviceAcceleration,
DeviceRotationRate,
DeviceOrientationEvent,
MediaAudio, or
MediaVideo.

25. The measurement system of claim 22, wherein:
the mobile terminal is further configured to authorize an access to the sensor to at least one of different browsers; and
the mobile terminal is further configured to record the data from a sensor and add time stamps on the data.

26. The measurement system of claim 22, wherein the mobile terminal is further configured to:
classify the collected data according to the application scenario to obtain a data type;
perform data analysis according to the data type to obtain an analysis result;
associate the analysis results with the operating parameters of the motion control system, record the analysis results; and
obtain the measurement result optimization parameter.

27. The measurement system of claim 26, wherein the obtained data types comprise at least one of the following:
noise data,
acceleration data, or
rotate data.

28. The measurement system of claim 26, wherein the mobile terminal is further configured to:
perform time sequence analysis on the continuously collected data of the running state according to the data type;
perform frequency domain analysis on the continuously collected data of the running state according to the data type; or
perform attribution analysis on the continuously collected data of the running state according to the data type.

29. The measurement system of claim 22, wherein the measurement system is further configured to:
detect and receive a signal that the motion control system starting to operate according to the control logic;
trigger a recording function of a collection event; and
perform data collection according to the collection event.

30. The measurement system of: claim 22, wherein the measurement system further configured to:
wirelessly connect the web server of the drive in the motion control system;
send information to pause an operation of the driver after obtaining sufficient data in continuous data collection; or
send information to terminate the operation of the driver after obtaining the purpose of optimization according to the continuously collected data; or
send information to restart the operation of the driver if does not obtain the purpose of optimization according to the continuously collected data.

31. The measurement system of claim 22, wherein the measurement system is further configured to:
associate a cause of the problem with the parameters of the driver, and inputting the parameters into the driver through the web server if does not obtain satisfactory measurement result optimization parameter the running state; or
provide the optimized parameters to the driver through the web server if obtains satisfactory measurement result optimization parameter of the running state, wherein the optimized parameters are used to indicate termination of the measurement.

32-34. (canceled)
